(19) United States
(12) Patent Application Publication
(10) Pub. No.: US 2020/0035196 A1
(43) Pub. Date: Jan. 30, 2020

(54) METHOD FOR ADJUSTING LUMINANCE OF RGBW LIQUID CRYSTAL DISPLAY AND LIQUID CRYSTAL DISPLAY

(71) Applicant: Wuhan China Star Optoelectronics Technology Co., Ltd, Wuhan, Hubei (CN)

(72) Inventors: Yuejun TANG, Wuhan, Hubei (CN); Yang CHEN, Wuhan, Hubei (CN); Xiaohui JIANG, Wuhan, Hubei (CN); Dandan LIU, Wuhan, Hubei (CN)

(21) Appl. No.: 15/740,186

(22) PCT Filed: Dec. 14, 2017
(86) PCT No.: PCT/CN2017/116041

§ 371 Date: Dec. 27, 2017

(30) Foreign Application Priority Data
Oct. 31, 2017 (CN) 201711043041.9

(51) Int. Cl. G09G 5/10; G02F 1/1335

(52) U.S. Cl. CPC G09G 5/10; G02F 1/133514; G09G 2320/0626; G02F 1/133611; G09G 2300/0465; G02F 1/133609

(57) ABSTRACT

A method for adjusting a luminance of a RGBW liquid crystal display is provided by the disclosure. The liquid crystal display includes a RGBW sub-pixel, wherein the luminance of the W sub-pixel is achieved by adjusting one or more of width, spacing, thickness of liquid crystal cell, and number of branch of a sub-pixel electrode corresponding to the W sub-pixel, channel region at the sub-pixel electrode corresponding to the W sub-pixel, and aperture ratio at the sub-pixel electrode corresponding to the W sub-pixel. A liquid crystal display is also provided by the disclosure, and the method for adjusting the luminance of the RGBW liquid crystal display is applicable for the luminance of the W sub-pixel for achieving the adjustment of the luminance of the W sub-pixel.

### RELATED APPLICATIONS

The present application is a National Phase of International Application Number PCT/CN2017/116041, filed Dec. 14, 2017, and claims the priority of China Application No. 201711043041.9, filed Oct. 31, 2017.

### FIELD OF THE DISCLOSURE

The disclosure relates to a display panel technology, and particularly to a method for adjusting a luminance of a RGBW liquid crystal display and a liquid crystal display.

### BACKGROUND

There is a RGB three colors display system in a liquid crystal display. However, with the improvement of resolution, a luminous efficiency of the liquid crystal display is required to improve so as to attain the purposes of low power consumption and high luminance, especially for products having the resolution of 4K and the above, and thus a RGBW four colors display system is put forward. The RGBW four colors system has not only a red sub-pixel (R), a green sub-pixel (G) and a blue sub-pixel (B), but also includes a luminance enhanced sub-pixel (W), so that all functions realizable by the RGB three colors system can be completely fulfilled, and has advantages such as high luminous efficiency and lower power consumption. However, the incorporation of a W sub-pixel also causes optical problems such as reduced color saturation of the liquid crystal displays, coordinate shift of white point color and the like. However, in some displays having too high PPI (4K resolution or above) and suitable for outdoors, the incorporation of the W sub-pixel fails to sufficiently fulfill the purpose of the increase in the luminous efficiency.

### SUMMARY

In order to overcome disadvantages in the prior art, the disclosure provides a method for adjusting a luminance of a RGBW liquid crystal display and a liquid crystal display, so as to improve the application range, display quality and visual comfort of the liquid crystal displays having the RGBW four colors display system.

The disclosure provides a method for adjusting a luminance of a RGBW liquid crystal display, wherein the liquid crystal display includes a RGBW sub-pixel, wherein the luminance of the W sub-pixel is achieved by adjusting one or more of width, spacing, thickness of liquid crystal cell, and number of branch of a sub-pixel electrode corresponding to the W sub-pixel, channel region at the sub-pixel electrode corresponding to the W sub-pixel, and aperture ratio at the sub-pixel electrode corresponding to the W sub-pixel.

Further, the adjusting the width of the sub-pixel electrode corresponding to the W sub-pixel is specifically by setting the width of the sub-pixel electrode corresponding to the W sub-pixel as greater than or smaller than the width of the sub-pixel electrode corresponding to the RGB sub-pixel for achieving the adjustment of the luminance of the W sub-pixel.

Further, the adjusting the spacing of the sub-pixel electrode corresponding to the W sub-pixel is specifically by setting the spacing between branches of the sub-pixel electrode corresponding to the W sub-pixel as greater than or smaller than the spacing between branches of the sub-pixel electrode corresponding to the RGB sub-pixel for achieving the adjustment of the luminance of the W sub-pixel.

Further, the adjusting the thickness of the liquid crystal cell of the sub-pixel electrode corresponding to the W sub-pixel is specifically by setting a height at the sub-pixel electrode corresponding to the W sub-pixel as higher than or lower than a height at the sub-pixel electrode corresponding to the RGB sub-pixel for achieving the adjustment of the luminance of the W sub-pixel.

Further, the adjusting the number of branch of the sub-pixel electrode corresponding to the W sub-pixel is specifically by setting the number of branch of the sub-pixel electrode corresponding to the W sub-pixel as greater than or smaller than the number of branch of the sub-pixel electrode corresponding to the RGB sub-pixel for achieving the adjustment of the luminance of the W sub-pixel.

Further, the adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel, and/or setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel.

Further, the adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel, or setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel.

Further, the adjusting the aperture ratio at the sub-pixel electrode corresponding to the W sub-pixel is specifically by setting the aperture ratio at the sub-pixel electrode corresponding to the W sub-pixel as greater than or smaller than the aperture ratio at the sub-pixel electrode corresponding to the RGB sub-pixel for achieving the adjustment of the luminance of the W sub-pixel.

The disclosure also provides a liquid crystal display including a color filter substrate and an array substrate. The color filter substrate includes a RGBW sub-pixel, and the array substrate includes a sub-pixel electrode corresponding to the RGBW sub-pixels, and a method for adjusting a luminance of the RGBW liquid crystal display is applicable for the luminance of the W sub-pixel for achieving the adjustment of the luminance of the W sub-pixel.

Compared with the prior art, the disclosure achieves the adjustment of the luminance of the W sub-pixel by adjusting one or more of width, spacing, thickness of liquid crystal cell, and number of branch of the sub-pixel electrode corresponding to the W sub-pixel, channel region at the sub-pixel electrode corresponding to the W sub-pixel, and aperture ratio at the sub-pixel electrode corresponding to the W sub-pixel, and overcomes the detects of liquid crystal displays having a RGBW four colors display system, expands advantages of the liquid crystal displays having the RGBW four colors display system and improves the application range, display quality and visual comfort of the liquid crystal displays having the RGBW four colors display system.

### BRIEF DESCRIPTION OF HE DRAWINGS

FIG. 1-1 is a structural schematic view of the sub-pixel electrode corresponding to the W sub-pixel of Embodiment I of the disclosure;

FIG. 1-2 is a structural schematic view of the sub-pixel electrode corresponding to the W sub-pixel of Embodiment II of the disclosure;

FIG. 2-1 is a structural schematic view of the sub-pixel electrode corresponding to the W sub-pixel of Embodiment III of the disclosure;

FIG. 2-2 is a structural schematic view of the sub-pixel electrode corresponding to the W sub-pixel of Embodiment IV of the disclosure;

FIG. 3-1 is a structural schematic view of the sub-pixel electrode corresponding to the W sub-pixel of Embodiment V of the disclosure;

FIG. 3-2 is a structural schematic view of the sub-pixel electrode corresponding to the W sub-pixel of Embodiment VI of the disclosure;

FIG. 4-1 is a schematic view I of the channel region at the sub-pixel electrode corresponding to the W sub-pixel in the prior art;

FIG. 4-2 is a schematic view II of the channel region at the sub-pixel electrode corresponding to the W sub-pixel in the prior art;

FIG. 4-3 is a structural schematic view of the channel region at the sub-pixel electrode corresponding to the W sub-pixel of Embodiment VII of the disclosure;

FIG. 4-4 is a structural schematic view of the channel region at the sub-pixel electrode corresponding to the W sub-pixel of Embodiment VIII of the disclosure;

FIG. 4-5 is a structural schematic view of the channel region at the sub-pixel electrode corresponding to the W sub-pixel of Embodiment IX of the disclosure;

FIG. 4-6 is a structural schematic view of the channel region at the sub-pixel electrode corresponding to the W sub-pixel of Embodiment X of the disclosure;

FIG. 5-1 is a schematic view of area of the W sub-pixel in the prior art;

FIG. 5-2 is a schematic view of area of the W sub-pixel of Embodiment XI of the disclosure;

FIG. 5-3 is a schematic view of area of the W sub-pixel of Embodiment XII of the disclosure.

### DETAILED DESCRIPTION OF PREFERRED EMBODIMENTS

The disclosure is further described below in detail in combination with the accompanying drawings and embodiments. The disclosure, however, may be embodied in various different forms, and should not be construed as being limited to the illustrated specific embodiments herein. Rather, these embodiments are provided to explain principles of the disclosure and actual application thereof, so that a person skilled in the art can understand the various embodiments of the disclosure and various modifications used for the particular intended application.

The disclosure discloses a method for adjusting a luminance of a RGBW liquid crystal display. The liquid crystal display includes a RGB W sub-pixel, wherein the luminance of the W sub-pixel is achieved by adjusting one or more of width, spacing, thickness of liquid crystal cell, and number of branch of a sub-pixel electrode corresponding to the W sub-pixel, channel region at the sub-pixel electrode corresponding to the W sub-pixel, aperture ratio at the sub-pixel electrode corresponding to the W sub-pixel, wherein

adjusting the width of the sub-pixel electrode corresponding to the W sub-pixel is specifically by setting the width of the sub-pixel electrode corresponding to the W sub-pixel as greater than or smaller than the width of the sub-pixel electrode corresponding to the RGB sub-pixel for achieving the adjustment of the luminance of the W sub-pixel;

adjusting the spacing of the sub-pixel electrode corresponding to the W sub-pixel is specifically by setting the spacing between branches of the sub-pixel electrode corresponding to the W sub-pixel as greater than or smaller than the spacing between branches of the sub-pixel electrode corresponding to the RGB sub-pixel for achieving the adjustment of the luminance of the W sub-pixel;

adjusting the thickness of the liquid crystal cell of the sub-pixel electrode corresponding to the W sub-pixel is specifically by setting a height at the sub-pixel electrode corresponding to the W sub-pixel as higher than or lower than a height at the sub-pixel electrode corresponding to the RGB sub-pixel for achieving the adjustment of the luminance of the W sub-pixel;

adjusting the number of branch of the sub-pixel electrode corresponding to the W sub-pixel is specifically by setting the number of branch of the sub-pixel electrode corresponding to the W sub-pixel as greater than or smaller than the number of branch of the sub-pixel electrode corresponding to the RGB sub-pixel for achieving the adjustment of the luminance of the W sub-pixel;

adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel and/or setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel. Optionally, setting the width of the channel region at the sub-pixel electrode corresponding to the W sub-pixel as greater than or smaller than the width of the channel region at the sub-pixel electrode corresponding to the RGB sub-pixel, or setting the length of the channel region at the sub-pixel electrode corresponding to the W sub-pixel as greater than or smaller than the length of the channel region at the sub-pixel electrode corresponding to the RGB sub-pixel for achieving the adjustment of the luminance of the W sub-pixel. The width of the channel region refers to a length that a carrier in a TFT (Thin-film transistor) flows, and the length of the channel region refers to a cross-sectional area that a carrier in TFT (Thin-film transistor) flows.

Adjusting the aperture ratio at the sub-pixel electrode corresponding to the W sub-pixel is specifically by setting the aperture ratio at the sub-pixel electrode corresponding to the W sub-pixel as greater than or smaller than the aperture ratio at the sub-pixel electrode corresponding to the RGB sub-pixel for achieving the adjustment of the luminance of the W sub-pixel. Specifically, the adjustment of the aperture ratio at W sub-pixel is achieved by changing the area of the W sub-pixel. As an embodiment, the area of the W sub-pixel may be realized by widening a line width of a black matrix in the W sub-pixel region.

During the adjustment of the luminance of the W sub-pixel in the disclosure, when the W sub-pixel in the disclosure has higher luminance than that of a routine W sub-pixel, the disclosure may be suitable for a first applicable scene. In the first applicable scene, the W sub-pixel is designed to have higher luminous efficiency, better attain low power consumption and high luminance of the liquid crystal display, and be usable for outdoor display/wording display and the like. When the W sub-pixel in the disclosure has less luminance than that of the routine W sub-pixel, the disclosure may be used for a second applicable scene and the W sub-pixel is designed to have less luminous efficiency, reduce optical problems such as the decrease of color saturation and coordinate shift of white point color due to the incorporation of the W sub-pixel, and be used for a. liquid crystal display demanding an image quality and having indoor display/picture display and the like.

### Embodiment I

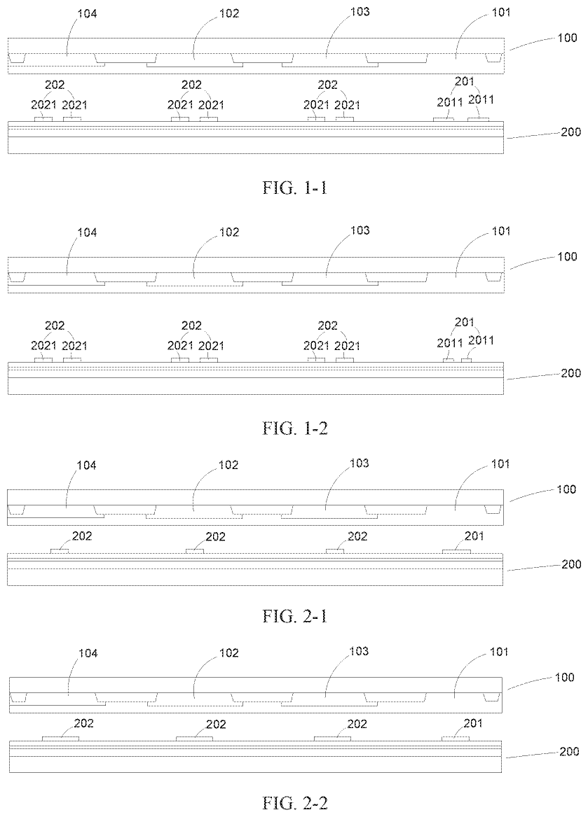

As shown in FIG. 1-1, an increase in a luminance of a W sub-pixel is achieved by setting a width of a sub-pixel electrode 201 on an array substrate 200 corresponding to a W sub-pixel 101 on a color filter substrate 100 as greater than a width of a sub-pixel electrode 202 corresponding to RGB sub-pixels (102, 103, and 104), and adjusting a spacing between branches 2011 of the sub-pixel electrode 201 corresponding to the W sub-pixel 101 as greater than a spacing between branches 2021 of the sub-pixel electrode 202 corresponding to the RGB sub-pixels (102, 103, and 104). However, the disclosure is not limited thereto. The increase of the luminance of the W sub-pixel is also achieved by setting the width of the sub-pixel electrode 201 on the array substrate 200 corresponding to the W sub-pixel 101 on the color filter substrate 100 as greater than the width of the sub-pixel electrode 202 corresponding to the RGB sub-pixels (102, 103, and 104), and setting the spacing between the branches 2011 of the sub-pixel electrode 201 corresponding to the W sub-pixel 101 as equal to the branches 2021 of the sub-pixel electrode 202 corresponding to the RGB sub-pixels (102, 103, and 104). Namely, the luminance of the W sub-pixel is higher with respect to the luminance of the routine W sub-pixel. The embodiment is suitable for the first applicable scene. Herein, a figure of the sub-pixel electrode may use electrode patterns in the prior art, and there are no specific limitation on them.

### Embodiment II

As shown in FIG. 1-2, an decrease of a luminance of a W sub-pixel is achieved by setting the width of the sub-pixel electrode 201 on the array substrate 200 corresponding to the W sub-pixel 101 on the color filter substrate 100 as smaller than the width of the sub-pixel electrode 202 corresponding. to the RGB sub-pixels (102, 103, and 104), and adjusting the spacing between branches 2011 of the sub-pixel electrode 201 corresponding to the W sub-pixel 101 as smaller than the branches 2021 of the sub-pixel electrode 202 corresponding to the RGB sub-pixels (102, 103, and 104). Namely, the luminance of the W sub-pixel is higher with respect to the luminance of the routine W sub-pixel. The embodiment is suitable for the second applicable scene. Herein, a figure of the sub-pixel electrode may use electrode patterns in the prior art, and there are no specific limitation on them.

### Embodiment III

As shown in FIG. 2-1, an increase of a luminance of a W sub-pixel is achieved by setting the width of the sub-pixel electrode 201 on the array substrate 200 corresponding to the W sub-pixel 101 on the color filter substrate 100 as greater than the width of the sub-pixel electrode 202 corresponding to the RGB sub-pixels (102, 103, and 104). Namely, the luminance of the W sub-pixel is higher with respect to the luminance of the routine W sub-pixel. The embodiment is suitable for the first applicable scene. Herein, a figure of the sub-pixel electrode may use electrode patterns in the prior art, and there are no specific limitation on them.

In Embodiment III, the number of branches and the spacing of the sub-pixel electrode corresponding to the RGBW sub-pixels is the same.

### Embodiment IV

As shown in FIG. 2-2, a decrease of a luminance of a W sub-pixel is achieved by setting the width of the sub-pixel electrode 201 on the array substrate 200 corresponding to the W sub-pixel 101 on the color filter substrate 100 as smaller than the width of the sub-pixel electrode 202 corresponding to the RGB sub-pixels (102, 103, and 104). Namely, the luminance of the W sub-pixel is lower with respect to the luminance of the routine W sub-pixel. The embodiment is suitable for the second applicable scene. Herein, a figure of the sub-pixel electrode may use electrode patterns in the prior art, and there are no specific limitation on them. However, the disclosure is not limited thereto. An adjustment of a luminance of a W sub-pixel is further achieved by combining with the arrangement of or directly setting the number of branches of the sub-pixel electrode 201 on the array substrate 200 corresponding to the W sub-pixel 101 on the color filter substrate 100 as smaller than the number of branches of the sub-pixel electrode corresponding to the RGB sub-pixels, for example, the sub-pixel electrode corresponding to the RGB sub-pixels has 2 slit branches (not shown) and the sub-pixel electrode corresponding to the W sub-pixels has 1 slit branch.

### Embodiment V

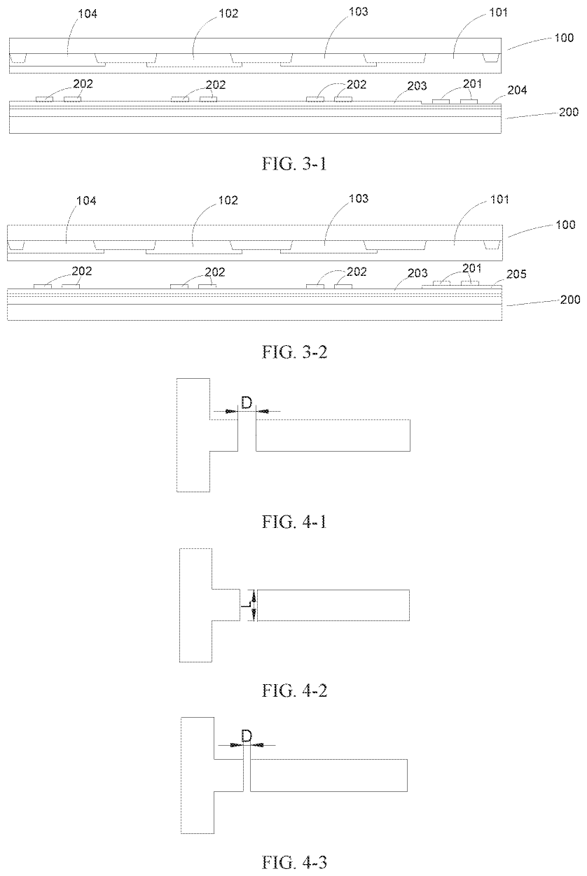

As shown in FIG. 3-1, an increase of a luminance of a W sub-pixel is achieved by setting a height at the sub-pixel electrode 201 on the array substrate 200 corresponding to the W sub-pixel 101 on the color filter substrate 100 as lower than a height at the sub-pixel electrode 202 corresponding to the RGB sub-pixels (102, 103, and 104); specifically, an over coat 203 in the array substrate 200 at a position corresponding to the W sub-pixel 101 is etched and a counterbore 204 is formed, and the sub-pixel electrode 201 corresponding to the W sub-pixel 101 is provided in the counterbore 204, so as to achieve the height at the sub-pixel electrode 201 on the array substrate 200 corresponding to the W sub-pixel 101 on the color filter substrate 100 lower than the height at the sub-pixel electrode 202 corresponding to the RGB sub-pixels (102, 103, and 104), so that a thickness of a liquid crystal cell at the position of the W sub-pixel is greater than a thickness of a liquid crystal cell at the position of the RGB sub-pixel for achieving the increase of the luminance of the W sub-pixel. Namely, the luminance of the W sub-pixel is higher with respect to the luminance of the routine W sub-pixel. The embodiment is suitable for the first applicable scene.

In Embodiment V, the spacing, width and electrode pattern of the sub-pixel electrode corresponding to the RGBW sub-pixels is all the same.

### Embodiment VI

As shown in FIG. 3-2, an decrease of a luminance of a W sub-pixel is achieved by setting the height at the sub-pixel electrode 201 on the array substrate 200 corresponding to the W sub-pixel 101 on the color filter substrate 100 as higher than the height at the sub-pixel electrode 202 corresponding to the RGB sub-pixels (102, 103, and 104); specifically, the over coat 203 in the array substrate 200 at the position corresponding to the W sub-pixel 101 is thickened and a raised platform 205 is formed herein, and the sub-pixel electrode 201 corresponding to the W sub-pixel 101 is provided on the raised platform 205, so as to achieve the height at the sub-pixel electrode 201 on the array substrate 200 corresponding to the W sub-pixel 101 on the color filter substrate 100 higher than the height at the sub-pixel electrode 202 corresponding to the RGB sub-pixels (102, 103, and 104), so that the thickness of the liquid crystal cell at the position of the W sub-pixel is smaller than the thickness of the liquid crystal cell at the position of the RGB sub-pixel for achieving the decrease of the luminance of the W sub-pixel. Namely, the luminance of the W sub-pixel is lower with respect to the luminance of the routine W sub-pixel. The embodiment is suitable for the second applicable scene.

The raised platform 205 may be obtained by etching the over coat 203 in the region outside the sub-pixel electrode 201 corresponding to the W sub-pixel 101. However, the disclosure is not limited thereto. For example, the raised platform 205 may be obtained by depositing and etching an insulating layer in the region outside the sub-pixel electrode 201 corresponding to the W sub-pixel 101.

In Embodiment VI, the spacing, width and electrode pattern of the sub-pixel electrode corresponding to the RGBW sub-pixels is all the same.

In the disclosure, FIGS. 4-1 and 4-6 only schematically show a schematic view of a width D and a length L of a channel region.

### Embodiment VII

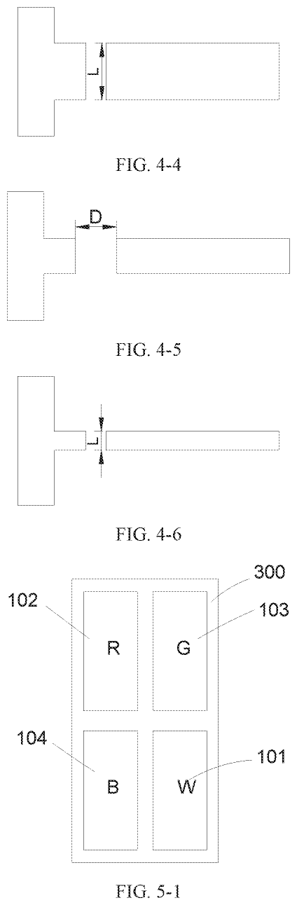

As shown in FIG. 4-1, FIG. 4-1 is the schematic view of the channel region at the sub-pixel electrode corresponding to the W sub-pixel in the prior art. Channel regions at sub-pixel electrode of the RGBW sub-pixels are generally the same. As shown in FIG. 4-3, by adjusting the width D of the channel region at the sub-pixel electrode corresponding to the W sub-pixel as smaller than the width D of the channel region at the sub-pixel electrode corresponding to the RGB sub-pixel, the embodiment 7 allows carriers to pass through the channel region more quickly and has higher charging efficiency, thereby increasing the luminance of the W sub-pixel. Namely, the luminance of the W sub-pixel is higher with respect to the luminance of the routine W sub-pixel. The embodiment is suitable for the first applicable scene.

### Embodiment VIII

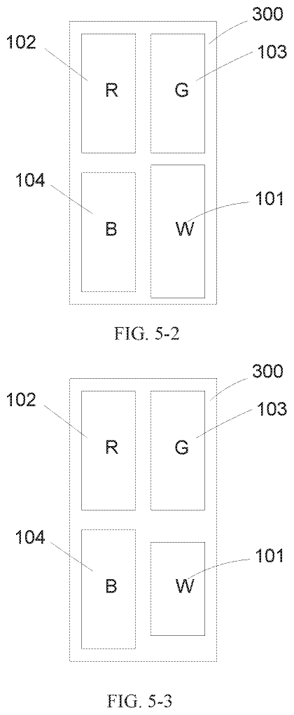

As shown in FIG. 4-5, adjusting the width D of the channel region at the sub-pixel electrode corresponding to the W sub-pixel as greater than the width D of the channel region at the sub-pixel electrode corresponding to the RGB sub-pixel allows carriers to pass through the channel region more slowly and has lower charging efficiency, thereby decreasing the luminance of the W sub-pixel. Namely, the luminance of the W sub-pixel is lower with respect to the luminance of the routine W sub-pixel. The embodiment is suitable for the second applicable scene.

### Embodiment IX

As shown in FIG. 4-2, FIG. 4-2 is the schematic view of the channel region at the sub-pixel electrode corresponding to the W sub-pixel in the prior art. Channel regions at sub-pixel electrode of the RGBW sub-pixels are generally the same. As shown in FIG. 4-4, by adjusting the length L of the channel region at the sub-pixel electrode corresponding to the W sub-pixel as greater than the length L of the channel region at the sub-pixel electrode corresponding to the RGB sub-pixel and keeping the width of the channel region at the sub-pixel electrode corresponding to the W sub-pixel and the width of the channel region at the sub-pixel electrode corresponding to the RGB sub-pixel unchanged, namely the width is the same, Embodiment IX has higher charging efficiency, thereby increasing the luminance of the W sub-pixel. Namely, the luminance of the W sub-pixel is higher with respect to the luminance of the routine W sub-pixel. The embodiment is suitable for the first applicable scene.

### Embodiment X

As shown in FIG. 4-6, by adjusting the length L of the channel region at the sub-pixel electrode corresponding to the W sub-pixel as shorter than the length L of the channel region at the sub-pixel electrode corresponding to the RGB sub-pixel and keeping the width D of the channel region at the sub-pixel electrode corresponding to the W sub-pixel and the width D of the channel region at the sub-pixel electrode corresponding to the RGB sub-pixel unchanged, namely the width is the same, the embodiment 10 has lower charging efficiency, thereby decreasing the luminance of the W sub-pixel. Namely, the luminance of the W sub-pixel is lower with respect to the luminance of the routine W sub-pixel. The embodiment is suitable for the second applicable scene.

### Embodiment XI

As shown in FIG. 5-1, areas of RGBW sub-pixels are the same in the prior art, and thus aperture ratios are the same. As shown in FIG. 5-2, an adjustment of the aperture ratio at the W sub-pixel is achieved by increasing the area of the W sub-pixel, namely making the area of the W sub-pixel bigger than the area of the RGB sub-pixels (102, 103, and 104). Specifically, a line width of a black matrix 300 in the region of the W sub-pixel 101 is configured as smaller than a line width of the black matrix 300 in the region of the RGB sub-pixels (102, 103, and 104), so as to achieve increased aperture ratio of the W sub-pixel, improved luminous efficiency, higher transmittance of the W sub-pixel and increased luminance of the W sub-pixel. Namely, the luminance of the W sub-pixel is higher with respect to the luminance of the routine W sub-pixel. The embodiment is suitable for the first applicable scene.

### Embodiment XII

As shown in FIG. 5-3, an adjustment of the aperture ratio at the W sub-pixel is achieved by reducing the area of the W sub-pixel, namely, making the area of the W sub-pixel smaller than the area of the RGB sub-pixel. Specifically, the line width of the black matrix 300 in the region of the W sub-pixel 101 is configured as smaller than the line width of the black matrix 300 in the region of the W sub-pixel 101, so as to achieve reduced aperture ratio of the W sub-pixel, smaller luminous efficiency, lower transmittance of the W sub-pixel and decreased luminance of the W sub-pixel. Namely, the luminance of the W sub-pixel is lower with respect to the luminance of the routine W sub-pixel. The embodiment is suitable for the second applicable scene.

The disclosure may also combine with two or more of Embodiments I-XII, thereby further meeting the requirements for the luminance of the W sub-pixel. The description thereof is omitted.

In the above Embodiments I-XII, the liquid crystal displays are FFS (Fringe Field Switching) mode of liquid crystal displays. Other modes of liquid crystal displays may obtain a design having brighter or darker W sub-pixel than that in a routine design using the methods of Embodiments I-XII. For example, the sub-pixel electrode corresponding to the W sub-pixel has a smaller area in a VA (Vertical Alignment) mode of liquid crystal display. The disclosure makes no limitation on display mode of liquid crystal displays.

As shown in FIG. 1-1, the disclosure further discloses a liquid crystal display including a color filter substrate 100 and an array substrate 200. The color filter substrate includes RGBW sub-pixels 102, 103, 104, 101, and the array substrate includes sub-pixel electrodes 202, 201 corresponding to RGBW sub-pixels. As for the luminance of the W sub-pixel 101, the adjustment of the luminance of the W sub-pixel is achieved by adopting one or more of the above methods for adjusting the luminance of the RGBW liquid crystal displays. Since the methods for adjusting the luminance of the RGBW liquid crystal displays have been previously described in detail, the description thereof is omitted.

Although the disclosure has been described with reference to the specific embodiments and drawings, it is to be understood by a person skilled in the art that the various changes in the forms and details may be made without departing from the spirit and the scope of the disclosure defined by the claims and the equivalents thereof.

What is claimed is:

1. A method for adjusting a luminance of a RGBW liquid crystal display, wherein the liquid crystal display comprises a RGBW sub-pixel, wherein the luminance of the W sub-pixel is achieved by adjusting one or more of width, spacing, thickness of liquid crystal cell, and number of branch of a sub-pixel electrode corresponding to the W sub-pixel, channel region at the sub-pixel electrode corresponding to the W sub-pixel, and aperture ratio at the sub-pixel electrode corresponding to the W sub-pixel.

2. The method for adjusting the luminance of the RGBW liquid crystal display according to claim 1, wherein the adjusting the width of the sub-pixel electrode corresponding to the W sub-pixel is specifically by setting the width of the sub-pixel electrode corresponding to the W sub-pixel as greater than or smaller than the width of the sub-pixel electrode corresponding to the RGB sub-pixel for achieving the adjustment of the luminance of the W sub-pixel.

3. The method for adjusting the luminance of the RGBW liquid crystal display according to claim 1, wherein the adjusting the spacing of the sub-pixel electrode corresponding to the W sub-pixel is specifically by setting the spacing between branches of the sub-pixel electrode corresponding to the W sub-pixel as greater than or smaller than the spacing between branches of the sub-pixel electrode corresponding to the RGB sub-pixel for achieving the adjustment of the luminance of the W sub-pixel.

4. The method for adjusting the luminance of the RGBW liquid crystal display according to claim 1, wherein the adjusting the thickness of the liquid crystal cell of the sub-pixel electrode corresponding to the W sub-pixel is specifically by setting a height at the sub-pixel electrode corresponding to the W sub-pixel as higher than or lower than a height at the sub-pixel electrode corresponding to the RGB sub-pixel for achieving the adjustment of the luminance of the W sub-pixel.

5. The method for adjusting the luminance of the RGBW liquid crystal display according to claim 1, wherein the adjusting the number of branch of the sub-pixel electrode corresponding to the W sub-pixel is specifically by setting the number of branch of the sub-pixel electrode corresponding to the W sub-pixel as greater than or smaller than the number of branch of the sub-pixel electrode corresponding to the RGB sub-pixel for achieving the adjustment of the luminance of the W sub-pixel.

6. The method for adjusting the luminance of the RGBW liquid crystal display according to claim 1, wherein the adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel, or setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel.

7. The method for adjusting the luminance of the RGBW liquid crystal display according to claim 1, wherein the adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel, and setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel.

8. The method for adjusting the luminance of the RGBW liquid crystal display according to claim 1, wherein the adjusting the aperture ratio at the sub-pixel electrode corresponding to the W sub-pixel is specifically by setting the aperture ratio at the sub-pixel electrode corresponding to the W sub-pixel as greater than or smaller than the aperture ratio at the sub-pixel electrode corresponding to the RGB sub-pixel for achieving the adjustment of the luminance of the W sub-pixel.

9. A liquid crystal display, comprising a color filter substrate and an array substrate, and the color filter substrate comprising a RGBW sub-pixel, and the array substrate comprising a sub-pixel electrode corresponding to the RGBW sub-pixels, wherein a method for adjusting a luminance of the RGBW liquid crystal display is applicable for the luminance of the W sub-pixel for achieving the adjustment of the luminance of the W sub-pixel; the liquid crystal display in the method for adjusting the luminance of the RGBW liquid crystal display comprises the RGBW sub-pixel, wherein the luminance of the W sub-pixel is achieved by adjusting one or more of width, spacing, thickness of liquid crystal cell, and number of branch of a sub-pixel electrode corresponding to the W sub-pixel, channel region at the sub-pixel electrode corresponding to the W sub-pixel, and aperture ratio at the sub-pixel electrode corresponding to the W sub-pixel.

10. The liquid crystal display according to claim 9, wherein the adjusting the width of the sub-pixel electrode corresponding to the W sub-pixel is specifically by setting the width of the sub-pixel electrode corresponding to the W sub-pixel as greater than or smaller than the width of the sub-pixel electrode corresponding to the RGB sub-pixel for achieving the adjustment of the luminance of the W sub-pixel.

11. The liquid crystal display according to claim 9, wherein the adjusting the spacing of the sub-pixel electrode corresponding to the W sub-pixel is specifically by setting the spacing between branches of the sub-pixel electrode corresponding to the W sub-pixel as greater than or smaller than the spacing between branches of the sub-pixel electrode corresponding to the RGB sub-pixel for achieving the adjustment of the luminance of the W sub-pixel.

12. The liquid crystal display according to claim 9, wherein the adjusting the thickness of the liquid crystal cell of the sub-pixel electrode corresponding to the W sub-pixel is specifically by setting a height at the sub-pixel electrode corresponding to the W sub-pixel as higher than or lower than a height at the sub-pixel electrode corresponding to the RGB sub-pixel for achieving the adjustment of the luminance of the W sub-pixel.

13. The liquid crystal display according to claim 9, wherein the adjusting the number of branch of the sub-pixel electrode corresponding to the W sub-pixel is specifically by setting the number of branch of the sub-pixel electrode corresponding to the W sub-pixel as greater than or smaller than the number of branch of the sub-pixel electrode corresponding to the RGB sub-pixel for achieving the adjustment of the luminance of the W sub-pixel.

14. The liquid crystal display according to claim 9, wherein, the adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel, or setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel.

15. The liquid crystal display according to claim 9, wherein the adjusting the channel region at the sub-pixel electrode corresponding to the W sub-pixel is specifically by setting a width of the channel region at the sub-pixel electrode corresponding to the W sub-pixel as greater than or smaller than a width of the channel region at the sub-pixel electrode corresponding to the RGB sub-pixel, and setting a length of the channel region at the sub-pixel electrode corresponding to the W sub-pixel as greater than or smaller than a length of the channel region at the sub-pixel electrode corresponding to the RGB sub-pixel for achieving the adjustment of the luminance of the W sub-pixel.

16. The liquid crystal display according to claim 9, wherein the adjusting the aperture ratio at the sub-pixel electrode corresponding to the W sub-pixel is specifically by setting the aperture ratio at the sub-pixel electrode corresponding to the W sub-pixel as greater than or smaller than the aperture ratio at the sub-pixel electrode corresponding to the RGB sub-pixel for achieving the adjustment of the luminance of the W sub-pixel.
